(19) United States
(12) Patent Application Publication
(10) Pub. No.: US 2026/0008559 A1
(43) Pub. Date: Jan. 8, 2026

(54) INSTRUMENT PANEL COMPRISING A VENTILATION DUCT

(71) Applicant: AIRBUS ATLANTIC, ROCHEFORT (FR)

(72) Inventors: Gilles ANDRIEU, MONTBERON (FR); Stephane FALGUERA, VILLON (FR)

(73) Assignee: AIRBUS ATLANTIC, ROCHEFORT (FR)

(21) Appl. No.: 18/845,032

(22) PCT Filed: Mar. 7, 2023
(86) PCT No.: PCT/EP2023/055730

§ 371 Date: Mar. 5, 2025

(30) Foreign Application Priority Data
Mar. 11, 2022 (FR) FR2202139

(51) Int. Cl. B64D 43/00

(52) U.S. Cl. CPC B64D 43/00

(57) ABSTRACT

The invention relates to a dashboard (3) comprising a main structure (4) extending longitudinally and having a concave shape, the main structure (4) comprising an upper face (42), the dashboard (3) being notable in that it comprises an upper cover (5) extending longitudinally along the length of the main structure (4), the upper cover (5) being mechanically connected to the main structure (4) and mounted on the upper face (42) of the main structure (4) so as to define a duct (W) for the circulation of an air flow between the upper face (42) of the main structure (4) and the upper cover (5), the upper face (42) comprising a plurality of orifices which are configured to allow the airflow to circulate inside the main structure (4).

### TECHNICAL FIELD

The present invention relates to the field of secondary structures of an aircraft and more specifically relates to an instrument panel of a flight deck of an airplane.

With reference to [FIG. 1], as an example, an airplane A extends longitudinally along an X axis, laterally along a Y axis et vertically along a Z axis, so as to form an orthogonal coordinate system (X, Y, Z). In such a coordinate system, the front and rear are defined along the X axis with reference to the movement of the airplane A in flight. In other words, the front and rear of the airplane A are defined along the X axis in [FIG. 1] which is oriented from the rear to the front. In addition, in such a coordinate system, the term “transversal” defines an object extending along the width of the airplane A in the plane (Y, Z). The airplane A comprises a cockpit C, mounted at the front of the airplane A and in which a flight deck 100 (represented in [FIG. 2]) is installed to fly the airplane A.

In a known manner, an airplane A flight deck 100, mounted in the cockpit C, comprises a plurality of interior items of furniture making it possible to receive the different items of equipment necessary for flying the airplane, such as flight control screens and command devices.

More precisely, with reference to [FIG. 2], the flight deck 100 comprises, in a known manner, a central pylon 101, arranged between the two seats intended for the pilot and the co-pilot of the airplane A and generally comprising the engine control lever, two lateral consoles 102, arranged on either side of the flight deck 100 and each accessible by the pilot or the co-pilot, and an instrument panel 103, extending substantially transversely to the front of the flight deck 100. Such an instrument panel 103 is notably configured to present to the pilot and the co-pilot the various screens for displaying data relating to navigation.

According to the prior art, an instrument panel 103 is an assembly of metal parts and panels, generally assembled by riveting or by means of bolts. Such a metal structure has the disadvantage of being heavy and complex to handle. Also known from document FR3089891A1 is an instrument panel made of composite material, comprising a one-piece main structure having a concave shape for receiving a plurality of control screens.

However, since the instrument panel 103 receives equipment such as control screens and flight control devices, it is necessary to cool them to avoid any risk of overheating. In this respect, it is known to mount a ventilation system 104 on the instrument panel 103, as represented in [FIG. 2]. The ventilation system 104 comprises in a known manner a conduit 105 in which circulates an air flow and a plurality of support members 106, connected to the instrument panel 103, to maintain the conduit 105. The conduit 105 extends along the instrument panel 103 on an upper surface and comprises through orifices for the emission of air flow into the instrument panel 103 in order to cool the equipment. The support members 106 are connected to the instrument panel 103 and make it possible both to maintain the conduit 105 in position and to fasten all the electrical systems, for example the power supply cables for the equipment mounted in the instrument panel 103 or instead the connecting cables to an on-board computer. Cladding panels are also added for esthetic needs.

However, in such a configuration, the added conduit 105 and the support members 106 have a significant mass, which must be supported by the instrument panel 103. Such a mass induces significant stresses in the instrument panel 103 and in the fastenings that connect it to the cockpit C, which presents a significant disadvantage. In addition, all of the added parts for the ventilation system 104 significantly increase the number of parts to be assembled in the cockpit C, which increases the complexity, costs and installation times of the flight deck P in the cockpit area.

The invention thus aims to eliminate at least some of these drawbacks by proposing an instrument panel and a ventilation system that are simple and rapid to install in a flight deck. In particular, the invention pertains to an assembly of an instrument panel and a ventilation system that participates in the mechanical strength of the assembly, without the ventilation system representing an additional load to be supported.

### DESCRIPTION OF THE INVENTION

The invention relates to an instrument panel configured to be mounted in a flight deck of an aircraft, said instrument panel comprising:
a main structure, extending longitudinally and having a concave shape, the main structure being configured to receive a plurality of navigation control and/or command equipment, the main structure comprising an upper face.

The instrument panel is remarkable in that it comprises an upper cover extending longitudinally along the length of the main structure, the upper cover being mechanically connected to the main structure and mounted on the upper face of the main structure, so as to define a duct for circulation of an air flow between the upper face of the main structure and the upper cover, the upper face comprising a plurality of orifices, configured to allow the circulation of the air flow within the main structure.

The instrument panel according to the invention advantageously makes it possible to dispense with the addition of an added ventilation conduit that adds mass and induces significant stresses in the instrument panel and in the flight deck.

The upper cover also makes it possible to stiffen the entire instrument panel structure, which must support heavy equipment. Thanks to the upper cover mechanically connected to the main structure, the assembly contributes to the mechanical strength of the instrument panel and makes it possible to solidify it. Unlike the prior art, wherein the main structure had to support an added conduit, the upper cover makes it possible to reinforce the main structure and improve its mechanical strength. The upper cover thus fulfills a first ventilation function and a second stiffening function.

The instrument panel according to the invention also advantageously makes it possible to minimize the number of parts in the flight deck, which makes it possible to both facilitate the installation of the instrument panel in the flight deck and to limit installation times. Reduced installation times make it possible to increase production line throughput, thus making it possible to limit costs and delays.

In one embodiment, the main structure being formed from a composite material, the upper cover is formed in one-piece from said composite material. Such a material allows the formation of a robust and lightweight upper cover, which makes it possible to limit the overall mass of the instrument panel and thus limit stresses in the fastenings that link it to the structure of the aircraft in which it is mounted. A main structure and an upper cover formed from a same material makes it possible to ensure that both parts of the instrument panel have the same behavior and similar mechanical and thermal characteristics.

Preferably, the upper cover is fastened to the main structure by “co-consolidation” or by cold bonding of said composite material, making it possible to dispense with added fasteners, of screw or insert type for example, which can weaken the connections and add mass. The term “co-consolidation” is taken to mean a method of welding by longitudinal local heating of one or both parts of the instrument panel.

In a first embodiment, the upper cover defines a single duct for circulation of an air flow between the top face of the main structure and the upper cover.

In a second embodiment, the upper cover defining at least two discontinuous air ducts, the instrument panel comprises a connecting member, projecting from the upper cover, configured to ensure a continuity of the air flow between the air ducts. Such a connecting member enables the mounting of the upper cover on a main structure in which is mounted a specific equipment obstructing the continuous duct, known and generally mounted in an instrument panel of an aircraft. The continuity of the air flow in the entire duct of the instrument panel is thus advantageously ensured.

Preferably, the upper face of the main structure has a concave shape. This makes it possible to increase the inner volume of the duct to increase the air flow circulating in the duct. The air flow traversing the duct is then sufficiently important to cool all the equipment mounted in the main structure.

The invention also relates to a flight deck comprising an instrument panel such as described previously.

The invention further pertains to an aircraft comprising a flight deck such as described previously.

Finally, the invention relates to a method for manufacturing the instrument panel such as described previously, said method comprises:
a step of formation of the upper cover in one-piece by thermoforming a plate of composite material, and
a step of fastening the upper cover to the upper face of the main structure, so as to form an inner duct for circulation of an air flow.

Preferably, in the fastening step, the upper cover is fastened to the upper face of the main structure by “co-consolidation” or bonding of the composite material.

Preferably, the method comprises a step of forming the main concave shaped structure in one-piece by thermoforming a plate of composite material.

Preferably, the composite material used for the formation of the main structure is compatible in terms of assembly with the composite material used for the formation of the upper cover.

Still preferably, the composite material used for the formation of the main structure and the composite material used for the formation of the upper cover are identical.

In one embodiment, the upper cover is formed in one-piece by stamping.

### DESCRIPTION OF THE FIGURES

The invention will be better understood upon reading the following description, given as an example, and referring to the following figures, given as non-limiting examples, wherein identical references are given to similar objects. 10

FIG. 1 is a schematic representation of an aircraft comprising a cockpit, in which is mounted a flight deck.

FIG. 2 is a schematic representation of a flight deck comprising an instrument panel and a ventilation system according to the prior art.

FIG. 3 is a schematic representation of a flight deck comprising an instrument panel according to one embodiment of the invention.

FIG. 4 is a schematic representation from the rear of the instrument panel of FIG. 3.

FIG. 5 is a schematic representation from the front of the instrument panel of FIG. 3,

FIG. 6 is an exploded schematic diagram of the instrument panel of FIG. 3,

It should be noted that the figures set out the invention in detail in order to implement the invention, said figures may of course be used to better define the invention where applicable.

### DETAILED DESCRIPTION OF THE INVENTION

The invention relates to an instrument panel, intended to be mounted in a cockpit of an aircraft. This document presents the example of an installation in an airplane, however it goes without saying that the instrument panel also could be installed in any type of aircraft.

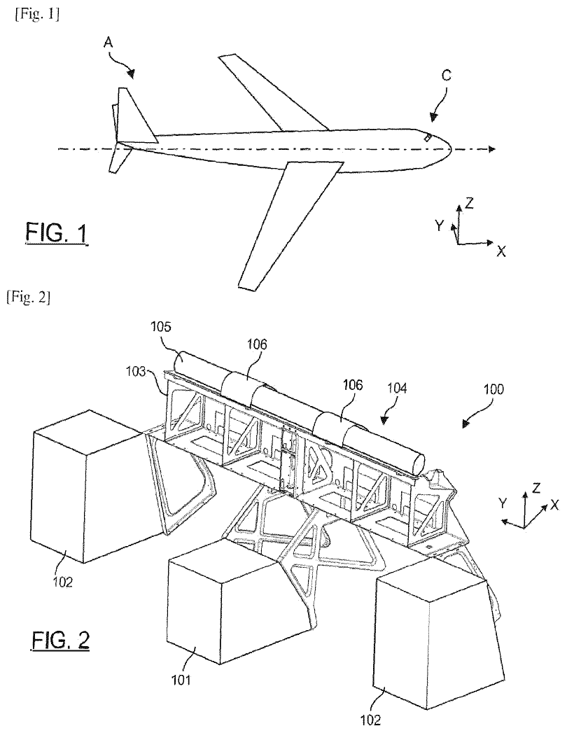

With reference to [FIG. 1], an airplane A is represented extending longitudinally along an X axis oriented from back to front, laterally along a Y axis oriented from right to left and vertically along an Z axis oriented from bottom to top so as to form an orthogonal reference system (X, Y, Z). In such a reference system, the term “horizontal” defines an object extending in the plane (X, Y) and the term “transversal”, an object extending in the plane (Y, Z).

In a known manner, the airplane A includes at the front a cockpit C, delimiting the fuselage portion located at the front of the airplane A and in which are found the pilot and the co-pilot. The cockpit C includes a structural framework configured to receive a flight deck P.

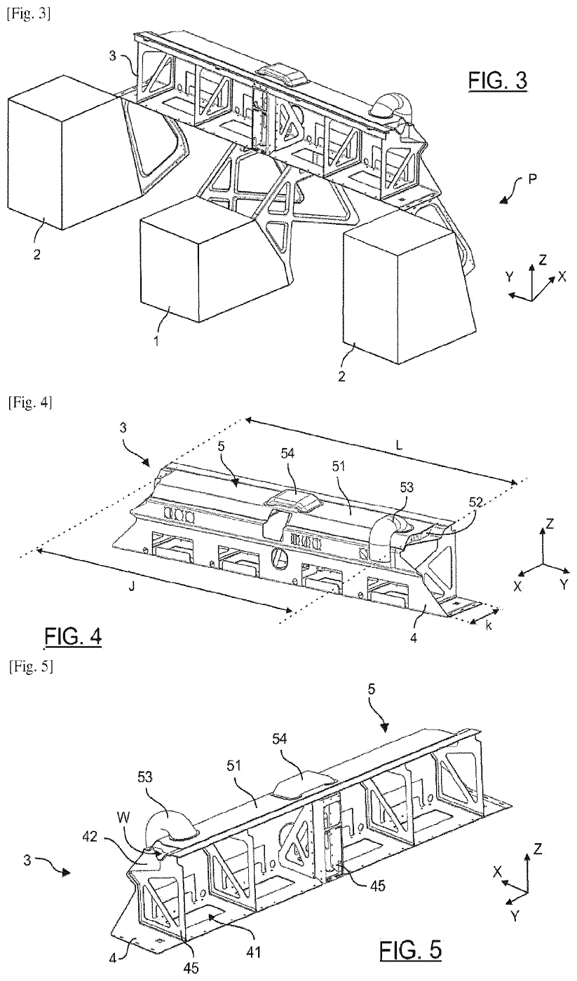

In a known manner, with reference to [FIG. 3], a flight deck P, mounted in the cockpit C, comprises a plurality of interior items of furniture making it possible to receive the different items of equipment necessary for flying the airplane A, such as control screens and flight command devices. In particular, the flight deck P comprises, in a known manner, a central pylon 1, arranged between the two seats intended for the pilot and the co-pilot of the airplane A, two lateral consoles 2, arranged on either side of the flight deck P, and an instrument panel 3 configured to present to the pilot and the co-pilot the different display screens of data relating to navigation.

The instrument panel 3 extends substantially transversely at the front of the flight deck P. In other words, the length of the instrument panel 3 extends in the width of the airplane A, along the Y axis so as to present to the pilot and the co-pilot a set of equipment, such as flight command and/or control devices, for example a plurality of display devices. In the remainder of this document, the front of the instrument panel 3 defines the face facing the pilot and the co-pilot in flight, i.e. the face of the instrument panel 3 oriented towards the rear of the cockpit C in the airplane A. In other words, the front and rear of the instrument panel 3 are reversed with respect to the front and rear of the flight deck P.

With reference to FIGS. 4 to 6, the instrument panel 3 according to the invention comprises a main structure 4 and an upper closure cover 5.

The main structure 4 has a concave shape defining a concavity 41 (represented in [FIG. 5]). The main structure 4 is configured to receive the plurality of navigation command and/or control equipment, such as display screens for example. In other words, in the plane (X, Z) formed in the reference system (X, Y, Z), the concavity 41 has substantially a cross-sectional C-shape, closed at the rear of the instrument panel 3 and open to the front of the instrument panel 3, i.e. to the rear of the flight deck P, so that the equipment can face the pilot and the co-pilot.

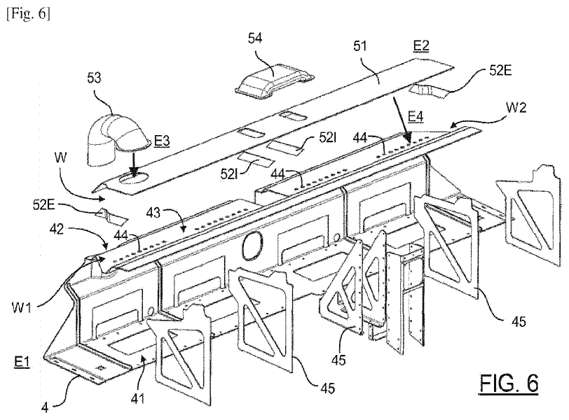

The main structure 4 comprises an upper face 42 (represented more precisely in [FIG. 6]). Preferably, the upper face 42 has a concave shape. More precisely, in this example, the upper face 42 comprises a groove 43, having a V-shape that allows the circulation of the air flow. Preferably, the upper face 42 (more precisely the groove 43) comprises a plurality of orifices 44, configured to allow the circulation of the air flow inside the main structure 4.

The main structure 4 extends longitudinally along the lateral Y axis and has, in this example, a length L proportional to the length of the cockpit C in which the instrument panel 3 is intended to be mounted. Similarly, the depth k of the concavity 41, i.e. the dimension along the axis X, may vary depending on the equipment intended to be mounted in the main structure 4.

Preferably, the main structure 4 is monobloc, i.e. formed in one-piece, so as to limit the junctions between several added parts, thus advantageously making it possible to reinforce the instrument panel 3.

Preferably, the main structure 4 is formed from a composite material. Still preferably, the main structure 4 is manufactured from a thermoplastic polymer material (of glass fiber type for example), enabling the manufacture of an instrument panel 3 that is both lightweight and robust. According to a preferred embodiment of the invention, such a main structure 4 is stiffened by partitions assembled by injection of thermoplastic material into a mold. It goes without saying that the main structure 4 could be manufactured from a different material, in particular from any metallic or composite material.

With reference to [FIG. 5], the main structure 4 comprises a plurality of internal partitions 45, configured to delimit a plurality of housings, intended to receive the plurality of equipment integrating strength functions or not. Each partition 45 extends longitudinally along the X axis, to delimit the plurality of housings successively transversely along the Y axis. Each partition 45 also makes it possible to provide the instrument panel 3 with transversal and torsional stiffness around the Y axis.

Still with reference to FIGS. 4 to 6, the upper cover 5 according to the invention extends longitudinally along the length of the main structure 4, i.e. along the Y axis. Preferably, the upper cover 5 has a length J substantially comparable to the length of the main structure 4. Still preferably, the length J of the upper cover 5 is slightly less than the length L of the main structure 4. Such a length J advantageously allows the upper cover 5 to be mounted on any type of existing instrument panel.

The upper cover 5 defines with the main structure 4, a duct W for circulation of an air flow for cooling the equipment mounted in the main structure 4.

In one embodiment, with reference to [FIG. 6], the upper cover 5 comprises an upper wall 51, preferably having a concave shape, so as to increase the inner volume of the duct W. The upper cover 5 also comprises two outer lateral walls 52E that laterally delimit the circulation duct W. In this example, the upper cover 5 further comprises two inner lateral walls 521 that make it possible to delimit two discontinuous ducts W1, W2 (represented in [FIG. 6]). It goes without saying that the upper cover 5 could comprise a different number of inner lateral walls 521, in particular a number greater than two, to delimit a number of discontinuous ducts W greater than two. Similarly, it goes without saying that the upper cover 5 could be exempt of inner lateral wall 521 so as to define a single duct W for circulation of an air flow.

The upper cover 5 also comprises an inlet conduit 53, allowing the supply of air and the introduction of the air flow into the duct W.

In one embodiment, the upper cover 5 comprises a connecting member 54, upwardly protruding from the upper cover 5, which connects the two discontinuous ducts W1, W2 on either side of the inner lateral walls 521, so as to ensure a continuity of the air flow. The connecting member 54 makes it possible to bypass an equipment that would have a significant height, commonly integrated in the concavity 41 in the middle of the length L of the main structure 4. Thus, the air flow can circulate throughout the entire duct W.

Preferably, the upper cover 5 is mounted on the upper face 42 of the main structure 4 so as to define the duct W for circulation of the air flow between the upper face 42 of the main structure 4 and the upper cover 5, as represented in [FIG. 5]. Since the duct W is formed directly in the instrument panel 3, it is not necessary to add an additional conduit, which would add mass and would induce significant additional stresses in the instrument panel 3.

Preferably, the upper cover 5 is fastened to the main structure 4 to allow the upper cover 5 to reinforce the instrument panel 3 and participate in its mechanical strength. In other words, thanks to the upper cover 5, the instrument panel 3 is more robust and can withstand higher stresses.

In one preferred embodiment, the upper cover 5 is formed in one-piece, to limit the fastenings between different parts. A one-piece upper cover 5 makes it possible to limit the appearance of weak zones in the structure, i.e. zones which are able to present concentrations of strains or greater stresses for example.

Preferably, the upper cover 5 is formed from a composite material. Still preferably, the upper cover 5 is manufactured from a thermoplastic polymer material (of glass fiber type for example), allowing the manufacture of an upper cover 5 that is both lightweight and robust. Preferably, the upper cover 5 is manufactured from a composite material compatible in terms of assembly (by “co-consolidation” or bonding) with the material of the main structure 4. Still preferably, the upper cover 5 is manufactured from the same composite material as the instrument panel 3, so as to facilitate their engagement while ensuring that the instrument panel 3 and the upper cover 5 have similar characteristics that allow them to deform for example in a similar manner. According to one preferred embodiment of the invention, such an upper cover 5 is manufactured by stamping or thermoforming thermoplastic material in a mold. It goes without saying that the upper cover 5 could be manufactured from a different material, in particular a metallic material.

In one embodiment, the upper cover 5 is fastened to the main structure 4 by “co-consolidation” of the composite material, i.e. by a local heating welding method. Such an assembly makes it possible to dispense with fastening devices, of screw or insert type for example, making it possible both to lighten the instrument panel 3, to dispense with mounting clearances between several parts and to limit strains due to connection stresses for example. Such a fastening of the upper cover 5 also makes it possible to ensure a simple and fast manufacture and mounting, making it possible to limit production costs. In the case of an upper cover 5 and a main structure 4 in a metal material, the upper cover 5 may for example be welded to the main structure 4, so as to limit the fastenings.

Alternatively, the upper cover 5 may be fastened to the main structure 4 by bonding. It goes without saying that the upper cover 5 may also be fastened to the main structure 4 by assembly by means of fastenings.

Preferably, the duct W has an inner volume allowing a sufficient volume of air to cool all the equipment mounted in the concavity 41 of the main structure 4.

A method for manufacturing an instrument panel 3 according to a preferred embodiment of the invention will now be described, with reference to [FIG. 6]. In this example, the main structure 4 and the upper cover 5 are made of a composite material, so as to form a lightweight and robust instrument panel 3.

The method first comprises a step of forming E1 the main structure 4, preferably in one-piece by thermoforming a composite material plate. Still preferably, the main structure 4 is formed by stamping. The formation of the main structure 4 makes it possible to form both a concavity 41 to receive the equipment and a groove 43 on the upper face 42 for the formation of the duct W, as will be described in more detail later.

The method then comprises a step of formation E2 of the upper wall 51 of the upper cover 5 in one-piece by thermoforming a plate of composite material. Still preferably, the upper cover 5 is formed by stamping. In this step, preferably, each lateral wall 52, the inlet conduit 53 and the deflection member 54 are also formed.

Each lateral wall 52, the inlet conduit 53 and the deflection member 54 are then successively fastened, in a third step E3, to the upper wall 51. Preferably, each lateral wall 52, the inlet conduit 53 and the deflection member 54 are fastened by an assembly method without fastening (e.g. bonding, welding, etc.) so as both to lighten the instrument panel 3, to dispense with assembly clearances between several parts and to limit strains due to connection stresses, for example. The mounting is thus simple and rapid.

The method then comprises a step of fastening E4 the upper cover 5 to the upper face 42 of the main structure 4 so as to form the inner duct W for circulation of an air flow between the groove 43 and the upper cover 5. Preferably, the upper cover 5 is fastened by “co-consolidation” of composite material. The instrument panel 3 is exempt of fastening device, of screw or insert type for example, which allows a lightweight and robust one-piece instrument panel 3 and makes it possible to limit mounting clearances.

The instrument panel 3 thus formed in one-piece comprises a duct W for the circulation of an air flow to cool the equipment mounted in the concavity 41 of the main structure 4. Thus, it is not necessary to add an additional conduit that would add mass and cause additional stresses as was the case in the prior art. It is also not necessary, thanks to the invention, to add fastenings for maintaining the electrical systems, such as the supply cables of the equipment mounted in the instrument panel for example or the connecting cables to an on-board computer, which represents a significant gain in mass.

In addition, such a one-piece instrument panel 3 directly integrating the ventilation function as well as electrical functions makes it possible to limit the installation times of the instrument panel 3 in the flight deck P, which advantageously makes it possible to increase production rates on aircraft assembly lines.

1. Instrument panel (3) configured to be mounted in a flight deck (P) of an aircraft, said instrument panel (3) comprising:
a main structure (4), extending longitudinally and having a concave shape, the main structure (4) being configured to receive a plurality of navigation command and/or control equipment, the main structure (4) comprising an upper face (42),
the instrument panel (3) being characterized in that it comprises an upper cover (5) extending longitudinally along the length of the main structure (4), the upper cover (5) being mechanically connected to the main structure (4) and mounted on the upper face (42) of the main structure (4), so as to define a duct (W) for circulation of an air flow between the upper face (42) of the main structure (4) and the upper cover (5), the upper face (42) comprising a plurality of orifices (44), configured to allow the circulation of the air flow within the main structure (4).

2. Instrument panel (3) according to claim 1, wherein, the main structure (4) being formed from a composite material, the upper cover (5) is formed in one-piece from said composite material.

3. Instrument panel (3) according to claim 2, wherein the upper cover (5) is fastened to the main structure (4) by “co-consolidation” or bonding of said composite material.

4. Instrument panel (3) according to one of claims 1 to 3, wherein the upper cover (5) defining at least two discontinuous air ducts (W1, W2), the instrument panel (3) comprises a connecting member (54), projecting from the upper cover (5), configured to ensure a continuity of the air flow between the air ducts (W1, W2),

5. Instrument panel (3) according to one of claims 1 to 4, wherein the upper face (42) of the main structure (4) has a concave shape.

6. Flight deck (P) comprising an instrument panel (3) according to one of claims 1 to 5.

7. Aircraft comprising a flight deck (P) according to claim 6.

8. Method for manufacturing an instrument panel (3) according to one of claims 1 to 5, said method comprises:
a step of forming (E2) the upper cover (5) in one-piece by thermoforming a plate of composite material, and
a step of fastening (E4) the upper cover (5) to the upper face (42) of the main structure (4), so as to form an inner duct (W) for circulation of an air flow.

9. Method for manufacturing the instrument panel (3) according to claim 8, said method comprising a step of formation (E1) of the main concave shaped structure (4) in one-piece by thermoforming a plate of composite material.

10. Method for manufacturing the instrument panel (3) according to one of claims 8 and 9, wherein the upper cover (5) is formed in one-piece by stamping.
